(19) United States
(12) Patent Application Publication
(10) Pub. No.: US 2009/0161303 A1
(43) Pub. Date: Jun. 25, 2009

(54) DOCKING STATION OF ELECTRONIC APPARATUS

(75) Inventor: Toshiyuki Hirota, Hino-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/256,260

(22) Filed: Oct. 22, 2008

(30) Foreign Application Priority Data
Dec. 21, 2007 (JP) 2007-331057

(51) Int. Cl. G06F 1/16

(52) U.S. Cl. 361/679.01

(57) ABSTRACT

According to one embodiment, a docking station for docking therewith a portable computer through connectors includes a docker side control apparatus for energizing an electromagnet to bring a securing mechanism of a PC into a state where the lock of the securing mechanism can be released, and an authentication control apparatus for authenticating a user through a fingerprint sensor or the like. When the user is authenticated as a regular user through the authentication control apparatus, the docker side control apparatus energizes the electromagnet to bring the securing by the securing mechanism into a state where the securing can be released.

### CROSS-REFERENCE TO RELATED APPLICATIONS

This application is based upon and claims the benefit of priority from Japanese Patent Application No. 2007-331057, filed Dec. 21, 2007, the entire contents of which are incorporated herein by reference.

### BACKGROUND

1. Field

One embodiment of the present invention relates to a docking station for docking therewith an electronic apparatus such as a portable computer and the like.

2. Description of the Related Art

Heretofore, a docking station for docking therewith a portable computer is known as an expansion unit of an electronic apparatus. It is disclosed by, for example, Jpn. Pat. Appln. KOKAI Publication No. 9-114546 (claim 1, and paragraphs [0008] to [0012]).

This docking station is provided with a lock mechanism for locking a computer, and an erect switch for releasing the lock.

In the apparatus disclosed in the publication, when the eject switch is depressed, it is determined whether or not the power of the docked computer is on. If the power is not on, the power of the computer is turned on. Further, the computer waits for an input of a password, and releases the lock of the docking station on condition that the password agrees.

As described above, when the eject switch of the docking station is depressed, the lock is released on condition that the password agrees, whereby the lock Is prevented from being illegally released, and the computer is prevented from being separated and taken away from the docking station.

However, in the apparatus described above, there is the possibility of the computer being taken away together with the docking station. As an antitheft means, use of an antitheft wire is generally known. However, a complicated operation and the like of number coincidence using a dial is required each time locking or release is performed. Further, when a key is used, management of the key is also troublesome. Further, when the key is lost, there is also the possibility of suffering damage of theft.

Further, in the apparatus disclosed in the publication described above, when the owner of the computer releases the docking, it is necessary for the power of the computer to be in the on-state. When the power is in the off-state, it is necessary to start the computer only for the purpose of releasing the lock. In this case, the computer takes a certain time to boot up, and hence there is the problem of lack of convenience. Particularly when the computer does not start normally, docking cannot be released.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiment of the invention and not to limit the scope of the invention.

FIG. 1 is a schematic side view showing a docking station of a portable computer according to an embodiment of the invention;

FIG. 2 is a bottom view showing a connection structure of a base side housing of the PC of FIG. 1;

FIG. 3 is a top view showing a state where the lock of a securing mechanism of a docker of FIG. 1 is released;

FIG. 4 is a top view showing a locked state of the securing mechanism of the docker of FIG. 1;

FIG. 5 is a schematic top view of the securing mechanism in the state of FIG. 3 viewed from above;

FIG. 6 is a schematic side view of the securing mechanism viewed from the direction of an arrow VI in FIG. 5;

FIG. 7 is a schematic top view of the securing mechanism in the state of FIG. 4 viewed from above;

FIG. 8 is a schematic side view of the securing mechanism viewed from the direction of an arrow VIII in FIG. 7;

FIG. 9 is a block diagram showing a control system for controlling the operation of the securing mechanism;

FIG. 10 is a schematic view for explaining an example in which a fingerprint sensor is provided on the top surface of the docker;

FIG. 11 is a schematic view for explaining an example in which an authentication button is provided on the top surface of the docker; and

FIG. 12 is a schematic view for explaining an example in which an antenna device for authentication is incorporated in the docker.

### DETAILED DESCRIPTION

Various embodiments according to the invention will be described hereinafter with reference to the accompanying drawings. In general according to one embodiment of the invention, a docking station 1 (hereinafter simply referred to as a docker 1) for docking therewith a portable computer 10 through connectors 2 and 16 is secured to a desk or the like through an antitheft wire 3. The docker 1 includes a docker side control apparatus 32 for energizing an electromagnet 27 to bring a securing mechanism of a PC 10 into a state where the lock of the securing mechanism can be released, and an authentication control apparatus 35 for authenticating a user through a fingerprint sensor or the like. When the user is authenticated as a regular user through the authentication control apparatus 35, the docker side control apparatus 32 energizes the electromagnet 27 to bring the securing by the securing mechanism into a state where the securing can be released.

An embodiment of the present invention will be described below in detail with reference to the accompanying drawings.

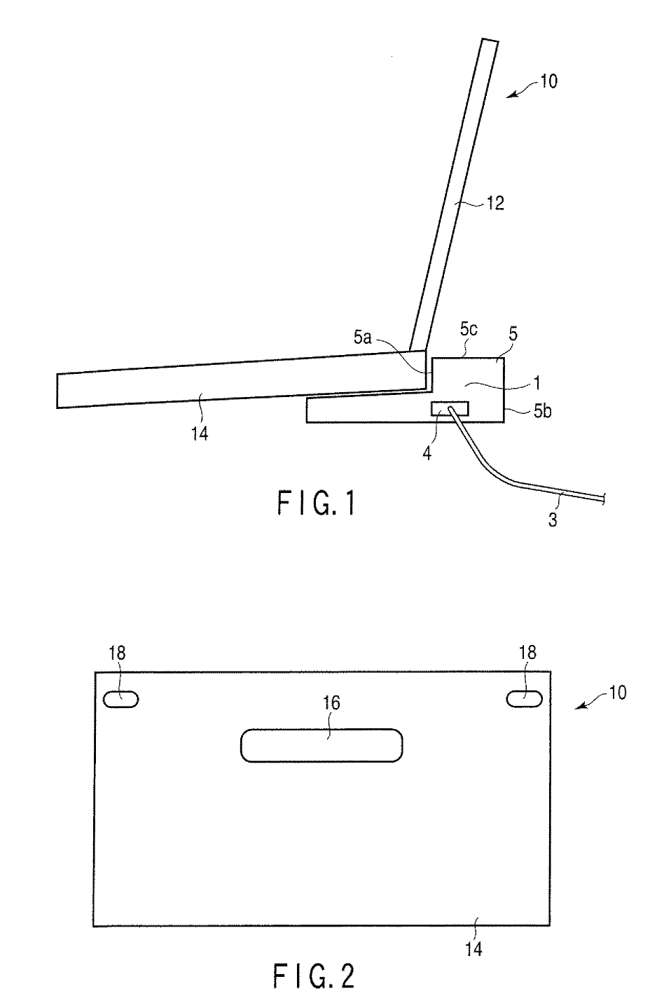

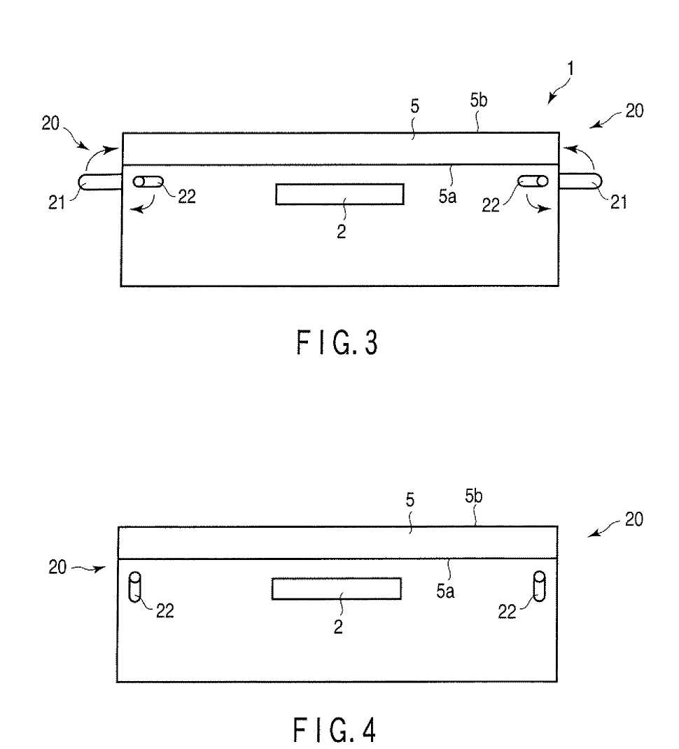

FIG. 1 shows a schematic side view of a state where a portable computer 10 (hereinafter simply referred to as a PC 10) as an electronic apparatus according to the embodiment of the present invention is docked with the docker 1. Further, FIG. 2 shows a bottom view of the PC 10 separated from the docker 1 viewed from the docker 1 side, and each of FIGS. 3 and 4 shows a plan view of the docker 1 from which the PC 10 is separated, viewed from the PC 10 side. Incidentally, FIG. 3 shows the state of the docker I where the lock of a securing mechanism (to be described later) 20 of the docker 1 is released, and FIG. 4 shows the state thereof where the securing mechanism 20 is locked.

In this embodiment, a docker 1 for docking a notebook PC 10 therewith will be explained representatively as a docking station of an electronic apparatus. However, the present invention can also be applied to a docker for docking therewith other portable electronic apparatus such as a personal digital assistant (PDA), cellular phone, music player, game machine, and the like.

As shown in FIG. 1, the PC 10 includes a display side housing 12 having a substantially rectangular plate-like shape, and a base side housing 14, and is configured by rotatably connecting the display side housing 12 to the rear end of the base side housing 14 through a hinge section. In FIG. 1, a state where the display side housing 12 is opened with respect to the base side housing 14 is shown. When the PC 10 is docked with the docker 1, a connector 16 on the bottom surface of the PC 10 shown in FIG. 2 is connected to a connector 2 (FIGS. 3 and 4) on the top surface of the docker 1, and the base side housing 14 of the PC 10 is docked with the docker 1. That is, in the state where the PC 10 is docked with the docker 1 as shown in FIG. 1, the PC 10 can be used by opening the display side housing 12. Incidentally, the PC 10 is not within the gist of the invention, and hence a detailed description thereof will be omitted here.

As shown in FIGS. 3 and 4, the connector 2 to be connected to the connector 16 (FIG. 2) on the bottom surface of the PC 10 is provided on the top surface of the docker 1. Further, the docker 1 includes, as is also shown in FIG. 1, a protrusion section 5 protruding rearward from the base side housing 14 of the PC 10 having a relatively large thickness Integrally as one body. A shoulder section 5a at which the protrusion section 5 is opposed to the rear end of the base side housing 14 of the PC 10 functions as a wall for positioning the PC 10. Further, on the rear end wall 5b of the protrusion section 5, connectors (not shown) such as a LAN port, USB port, and the like, and buttons (not shown) are provided.

Further, as shown in FIG. 1, securing metal fittings 4 for attaching an antitheft wire 3 are provided on the side surface of the docker 1. One end side of the wire 3 is attached to a fixed member in which the securing cannot be easily released such as a leg of a desk on which the docker 1 is placed in an undetachable manner. On the other hand, the other end side of the wire 3 is disconnectably connected to the securing metal fittings 4 of the docker 1 by means of a dial cylinder-lock or a mechanical lock. That is, the docker 1 is normally bound to the installation place by the antitheft wire 3.

Further, the docker 1 includes securing mechanisms 20 and 20 for securing the docked PC 10 near both ends thereof in the longitudinal direction as shown in FIGS. 3 and 4. Each of the securing mechanisms 20 includes a locking knob 21 operated by the user to be rotated, and a locking claw to be rotated together with the locking knob 21. The locking claw 22 is received by a locking hole 18 having an oblong shape on the PC side shown in FIG. 2 in the lock-released state shown in FIG. 3, and is engaged with an undersurface member of the base side housing 14 of the PC 10 in the locked state shown in FIG. 4.

That is, when the PC 10 is secured to the docker 1, first, the rear end part of the base side housing of the PC 10 is brought into contact with the shoulder section 5a of the docker 1, the connector 16 of the PC 10 is connected to the connector 2 of the docker 1, and the PC 10 is docked with the docker 1. At this time, the locking knobs 21 and 21 of the securing mechanisms 20 and 20 provided on the docker 1 are drawn out of the docker 1 in the state of FIG. 3. Further, after the PC 10 is docked with the docker 1, the locking knobs 21 and 21 are rotated from the state of FIG. 3 to the state of FIG. 4 (in the direction of arrows in FIG. 3), the two locking claws 22 and 22 are rotated in the state of FIG. 4, and the two locking claws 22 are engaged with the inside of the undersurface of the base side housing 14 of the PC 10. As a result of this, the PC 10 is secured to the docker 1.

The docker 1 of this embodiment is bound to the installation place by the antitheft wire 3 as described above, and hence the state where the PC 10 is secured to the docker 1 by the securing mechanisms 20 serves also as a theft-prevention measure. That is, by imparting the authority to release the lock of the securing mechanism 20 to the user of the PC 10, the security of the PC 10 against theft can be secured.

Here, the above-mentioned securing mechanism 20 will be described below in more detail with reference to FIGS. 5 to 8.

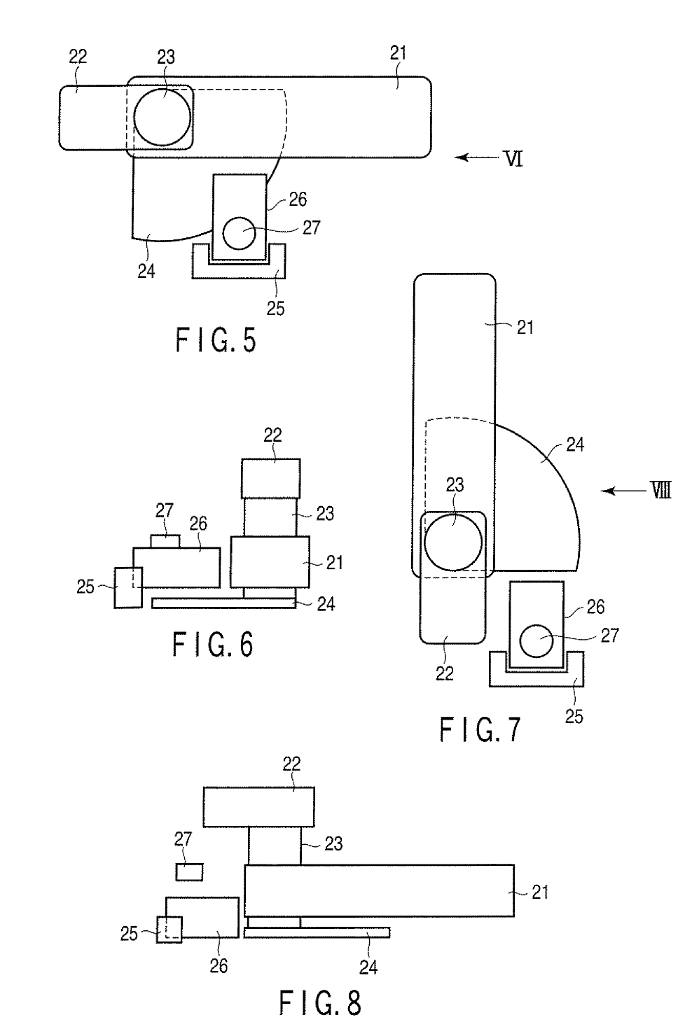

FIG. 5 shows a schematic top view of the securing mechanism 20 in the lock-released state viewed from the PC 10 side, and FIG. 6 shows a schematic side view of the securing mechanism 20 in the lock-released state viewed from the direction of an arrow VI in FIG. 5. Further, FIG. 7 shows a schematic top view of the securing mechanism 20 in the locked state viewed from the PC 10 side, and FIG. 8 shows a schematic side view of the securing mechanism 20 in the locked state viewed from the direction of an arrow VIII in FIG. 7. Incidentally, the two securing mechanisms 20 are symmetrical with each other, and hence one (on the right in FIG. 3) securing mechanism 20 will be described representatively here.

The securing mechanism 20 includes the locking knob 21 described above operated by the user, and the locking claw 22 described above rotating together with the locking knob 21 as one body. A rotation proximal end part of the locking knob 21, and a rotation proximal end part of the locking claw 22 are fixed to a common rotating shaft 23. The rotating shaft 23 extends in the vertical direction. Besides, a stopper 24 constituted of a flat plate having a substantially fan-like shape is fixed to the rotating shaft 23. As shown in FIGS. 6 and 8, the fanlike stopper 24 is fixed to the lower end of the rotating shaft 23, the locking claw 22 is fixed to the upper end thereof, and the locking knob 21 is fixed to the shaft 23 between the stopper 24 and the claw 22 so as to be separate from each other in the axial direction. That is, the locking knob 21, locking claw 22, and stopper 24 are rotated together with the rotating shaft 23 as one body.

A magnet 26 having a substantially rectangular block-like shape moving vertically along a guide 25 is provided in the rotation orbit of the stopper 24. The guide 25 is located at a position out of the orbit of the stopper 24. When arranged in the orbit of the stopper 24 as shown in FIG. 7, the magnet 26 operates to regulate the rotation of the stopper 24. Further, an electromagnet 27 for selectively attracting the magnet 26 is fixedly provided above the magnet 26. A metallic member that can be attracted to the electromagnet 27 may be used in place of the magnet 26.

That is, in a state shown in FIG. 6 where the electromagnet 27 is energized, and the magnet 26 is electromagnetically attracted to the electromagnet 27, the magnet 26 moves upwardly and gets out of the orbit of the stopper 24, and the stopper 24 becomes freely rotatable. In this state, the locking knob 21 and the locking claw 22 fixedly provided on the common rotating shaft 23 also become freely rotatable. That is, this state is the lock-releasable state.

Conversely, when the supply of power to the electromagnet 27 is stopped, and the magnet 26 is made to be separated from the electromagnet 27 by its own weight as shown in FIG. 8, the magnet 26 is arranged in the orbit of the stopper 24, and the rotation of the stopper 24 is forbidden as shown in FIG. 7. That is, this state is the lock-unreleasable state. That is, in the state where the electromagnet 27 is not energized, the locking knob 21 of the securing mechanism 20 is in the state where the operation thereof cannot be performed.

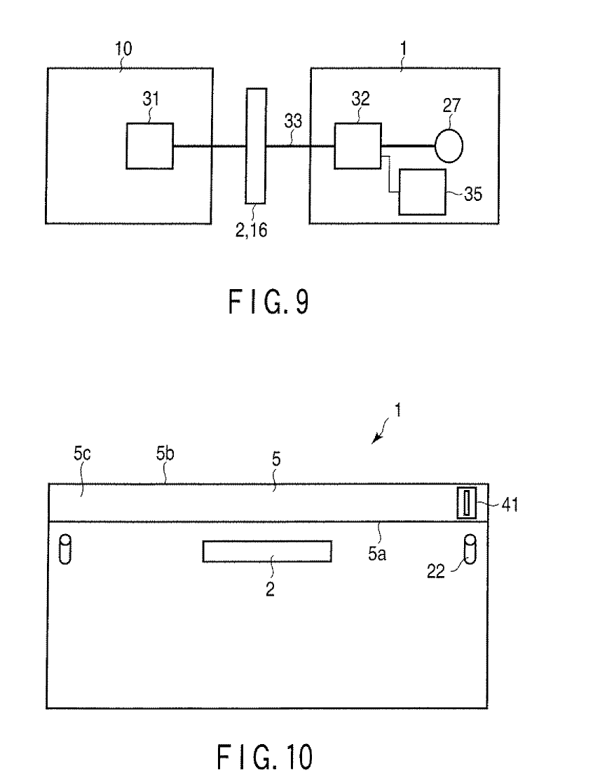

FIG. 9 shows a block diagram of a control system for controlling the operation of the securing mechanism 20 described above. The lock by the securing mechanism 20, and release of the lock are performed by controlling the supply of power to the electromagnet 27.

When the PC 10 is docked with the docker 1, the connector 2 of the docker 1 and the connector 16 of the PC 10 are connected to each other, whereby the PC side control apparatus 31 and the docker side control apparatus 32 are connected to each other by a signal line 33. The docker side control apparatus 32 functions as a control section of the invention. To the docker side control apparatus 32, the electromagnet 27 described above is connected, and the authentication control apparatus 35 which functions as the authentication means of the invention is also connected.

The authentication control apparatus 35 authenticates the user by collating the fingerprint of the user acquired through, for example, a fingerprint authentication sensor 41 shown in FIG. 10 with the fingerprint data registered in advance by the user. The fingerprint sensor 41 may be provided on the top surface 5c of the protrusion section 5 as shown in FIG. 10, and may also be provided on the side surface of the docker 1. In addition to the above, as the authentication method for identifying the user, there is a method in which private information such as a palm print and iris is read and collated.

The authentication control apparatus 35 determines the person to be the person provided with the authority to release the lock of the securing mechanism 20 on condition that the private information acquired from the user has coincided with the information registered in advance. Further, the docker side control apparatus 32 energizes the electromagnet 27, and brings the securing mechanism 20 into the state where the lock thereof can be released on the basis of the authentication result in the authentication control apparatus 35.

On the other hand, when it is determined by the authentication control apparatus 35 as a result of collating the private information with the registered information, that the collation is unsuccessful, the docker side control apparatus 32 forbids the supply of power to the electromagnet 27 on the basis of the authentication result of the authentication control apparatus 35. That is, in this state, the lock of the securing mechanism 20 cannot be released.

As described above, according to this embodiment, the docker 1 is bound to the installation place by the antitheft wire 3, the PC 10 docked with the docker 1 is locked by the securing mechanism 20 of the docker 1 side, then, in this state, the person provided with the authority to release the lock of the securing mechanism 20 is authenticated by the authentication control apparatus 35 of the docker 1 side, and the docker side control apparatus 32 brings the lock into a state where the lock can be selectively released, and hence it becomes possible to release the lock of the PC 10 irrespective of the on/off-state the power of the PC 10 or presence/absence of a fault, by a simple operation of the docker 1 side, while ensuring the security, and improve the convenience of the user. Further, in this case, the key for releasing the securing of the PC 10 is made unnecessary, the operability can be improved, and the labor for managing the key can be eliminated.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

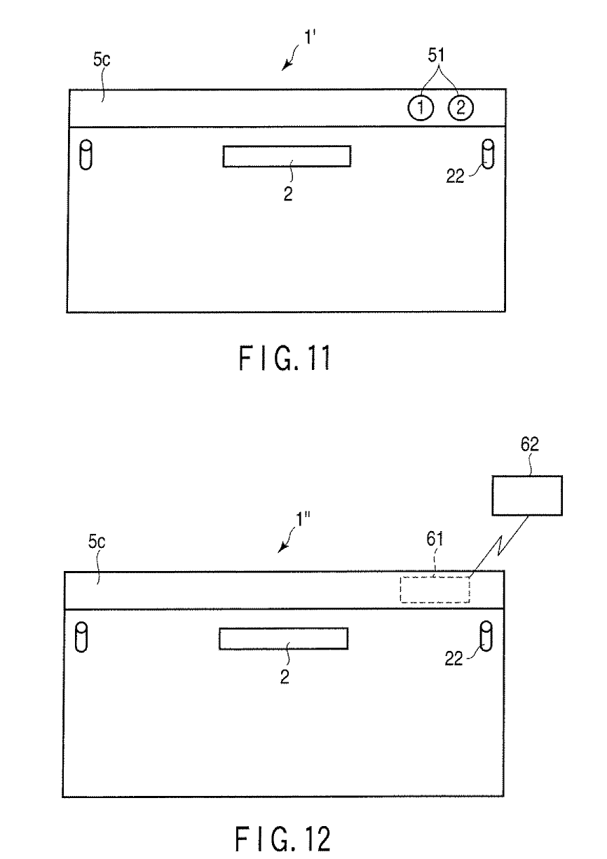

For example, in the embodiment described above, the case where the authentication control apparatus 35 reads the private information such as the fingerprint, palm print, iris, and the like of the user to authenticate the person has been explained. However, the invention is not limited to this, and the user may be authenticated by causing the user to operate the authentication buttons 51 provided on the docker 1′ side as shown in FIG. 11. In this case, for example, the user operates the two buttons of FIG. 11 in predetermined order, and the docker side control apparatus 32 energizes the electromagnet 27 to obtain the state where the lock can be released on condition that the order of the operation of the buttons coincides with the order registered in advance in the authentication control apparatus 35.

Further, as shown in, for example, FIG. 12, the authentication control apparatus 35 may authenticate a wireless communication terminal 62 owned by the user through an antenna device 61 incorporated in the docker 2″, and the docker side control apparatus 32 may energize the electromagnet 27 to obtain the state where the lock by the securing mechanism 20 can be released. In this case, the user can bring the lock of the PC 10 into a lock-releasable state by only having the wireless communication terminal 62 with him or her, and approaching the docker 1″, and thus the convenience can further be improved.

Incidentally, in the case where the authentication means is provided on the docker 1 side as in the embodiment described above, the authentication means such as the fingerprint sensor, or the like that has hitherto been mounted on the PC 10 side can be omitted, and the fingerprint sensor 41 and the authentication control apparatus 35 of the docker 1 can be utilized to authenticate the person who uses the PC 10. In this case, the authentication function is imparted to the docker 1 side, and the configuration of the PC 10 side can be simplified correspondingly, which can contribute to reduction in size and weight of the PC 10.

Furthermore, in the embodiment described above, although various authentication means provided on the docker 1 side are used to authenticate the user, and bring the lock of the securing mechanism 20 into the lock-releasable state, authentication means provided in the PC 10 connected to the docker 1 may be used to authenticate the user. In this case, although it is necessary to bring the PC 10 into the activated state, the operation for actually releasing the lock by the securing mechanism 20 is only the operation of the locking knob 21 provided on the docker 1, and hence it is possible to simplify the securing releasing operation while ensuring the security, and improve the convenience of the user.

What is claimed is:

1. A docking station for docking an electronic apparatus therewith comprising:
an antitheft wire for binding the docking station to an installation place thereof;
securing mechanisms for securing the electronic apparatus in a state where the apparatus is docked with the docking station to the docking station;
authentication means for authenticating whether or not a person is a person provided with the authority to release the securing by the securing mechanisms; and
a control section for making the securing by the securing mechanisms selectively releasable on the basis of an authentication result obtained by the authentication means.

2. The docking station of claim 1, wherein
the authentication means reads private information for identifying the person provided with the authority to release the securing by the securing mechanisms, and authenticates whether or not the person is provided with the authority.

3. The docking station of claim 1, wherein
the authentication means receives a specific key entry operation, and authenticates whether or not the person is provided with the authority.

4. The docking station of claim 1, wherein
the authentication means performs wireless communication with a wireless communication terminal provided with the authority to release the securing by the securing mechanisms, and authenticates whether or not the person is provided with the authority.
